(19) United States
(12) Patent Application Publication
(10) Pub. No.: US 2003/0094820 A1
(43) Pub. Date: May 22, 2003

(54) Latch drive assembly

(75) Inventor: Bernardo Erices, Berg Gladbach (DE)

Correspondence Address: NIXON PEABODY, LLP, 8180 GREENSBORO DRIVE, SUITE 800, MCLEAN, VA, 22102, US

(73) Assignee: ROBERT BOSCH GmbH, Stuttgart (DE)

(21) Appl. No.: 10/264,252

(22) Filed: Oct. 4, 2002

(30) Foreign Application Priority Data
Nov. 22, 2001 (DE) 101 57 173.9

(51) Int. Cl. E05B 15/02

(52) U.S. Cl. 292/341.16

(57) ABSTRACT

A latch drive assembly for a motor vehicle door lock having a latch drive assembly that maintains control of the displacement movements of the latch carrier during both locking and unlocking is achieved, in part, by a pre-tensioned blocking arrangement which automatically assumes a blocking position when a latch carrier is moved into the main closed position and holds the latch carrier in the main closed position. With this device, it is irrelevant whether the displacement of the latch carrier into the main closed position takes place by the corresponding displacement of an eccentric bolt of the latch drive or whether displacement takes place manually.

### BACKGROUND OF THE INVENTION

1. Field of the Invention

This invention relates to a latch drive assembly for a motor vehicle door lock that maintains control of the displacement movements of a latch carrier during both locking and unlocking. A blocking arrangement, which is mechanically pre-tensioned, automatically assumes its blocking position when the latch carrier is moved into the main closed position.

2. Description of Related Art

Motor vehicle door locks with a latch drive assembly of the type of this invention are equipped with the additional function of a so-called tightening aid. The tightening aid eliminates the otherwise necessary forceful slamming when the vehicle door is closed. The vehicle door can be closed with only little force, so that the pulling tight takes place automatically by the tightening aid, i.e., pulling tight involves closing the door such that all sealing elements are compressively-loaded and perform their sealing function.

One known device, shown in published German Patent Application DE 196 16 655 A1, includes a linearly guided latch carrier plate on which a latch, in this case a closing clip, is attached. The latch carrier plate can be moved between the pre-closed position and the main closed position. The pre-closed position is the position of the latch carrier plate in which the tightening aid is ready for operation; therefore, the door can be closed by gently slamming. A fork latch is then located, preferably in its main catch position, so that the subsequent displacement of the latch carrier plate from the pre-closed position into the main closed position causes the vehicle door to be pulled tight. This process is hereafter called locking. Accordingly, unlocking takes place when the latch carrier plate is moved from the main closed position into the pre-closed position.

The displacement of the latch carrier into the main closed position takes place in this device by an actuator against the force of a compression spring. The main closed position is maintained by a spring-loaded catch which fits into a shoulder in the latch carrier. Unlocking takes place by lifting the catch caused by the same actuator or by another actuator. The latch carrier then oscillates by the spring force of the compression spring against a stop back into the pre-closed position.

For emergency actuation, the latch carrier can be moved manually from the pre-closed position into the main closed position. Then, the latch carrier is also held by the spring-loaded catch.

In addition to the complex nature of the aforementioned device and the return stroke noise, which is inevitable during unlocking, the displacement motion of the latch carrier cannot be controlled during unlocking which is also regarded as a problem.

The same problem is exhibited by the device of German Patent DE 199 21 517 C2 which includes a latch carrier that is not linearly guided, but instead can be swiveled around an axis. For locking purposes, the latch carrier is shifted, via a coupling element coupled to a cam against a torsion spring, from the pre-closed position into the main closed position. The main closed position is in turn held via a catch which fits into the latch carrier.

Unlocking takes place by the cam continuing to run and being coupled to other kinematics such that the catch is lifted and the latch carrier swivels back suddenly, by the force of the torsion spring, against a stop into the pre-closed position. In this device, considerable return stroke noise can again be expected. In this device, manual displacement of the latch carrier from the pre-closed position into the main closed position is possible by the corresponding freewheel in the coupling element (i.e., provides for emergency actuation).

The known latch drive assembly of published German Patent Application DE 197 37 966 A1 has a latch carrier which is linearly guided and which can likewise be moved between the pre-closed position and the main closed position. The latch carrier is held by a compression spring in the pre-closed position and has a crank with which an eccentric bolt interacts. By the displacement of the eccentric bolt, the latch carrier can be moved against the force of the compression spring. It is particularly advantageous in this arrangement that each displacement motion of the latch carrier can be completely controlled by the cam. Thus, discontinuous displacement movements, which can lead to unwanted noise, can be prevented.

Like the two aforementioned devices, this latch carrier can also be moved manually from the pre-closed position into the main closed position. In order to ensure closing of the vehicle door in the case of cam failure, there is a manually actuated lever, i.e., a blocking arrangement, which keeps the latch carrier in the main closed position. This design however leads to complex manual actuation in case of a fault.

### SUMMARY OF THE INVENTION

A primary object of the present invention is to modify the known latch driver assembly such that there is comfortable operation, particularly in case of a fault, with a compact execution stroke and a low cost of manufacture.

One important aspect of the invention is that, while maintaining the control capacity of the displacement movements of the latch carrier, both during locking and unlocking, the blocking arrangement automatically assumes its blocking position when the latch carrier is moved into the main closed position. To do this, the blocking arrangement is accordingly mechanically pre-tensioned. In doing this, it is irrelevant whether the displacement of the latch carrier into the main closed position takes place by an existing drive or whether the displacement takes place manually.

An especially advantageous embodiment of the invention is achieved when the drive and the blocking arrangement are coupled such that, during an unlocking sequence of the drive, the blocking element is moved first into a non-blocking position and only then is unlocking carried out, which is controlled by the drive. The advantages that occur with such a device are that discontinuous displacement motions of the latch carrier are precluded and thus noise is greatly reduced.

### BRIEF DESCRIPTION OF THE DRAWINGS

FIG. 1 a plan view of a latch drive assembly of the invention in the pre-closed position;

FIG. 2 is a plan view of the latch drive assembly of FIG. 1 in the main closed position which is performed by means of a drive;

FIG. 3 is a plan view of the latch drive assembly of FIG. 1 during the unlocking sequence of the drive;

FIG. 4 is a plan view of the latch drive assembly of FIG. 1 in the main closed position which has been performed by manual actuation;

FIG. 5 is a side view of the latch carrier of FIG. 1 in the main closed position which has been performed by means of the drive.

### DETAILED DESCRIPTION OF THE INVENTION

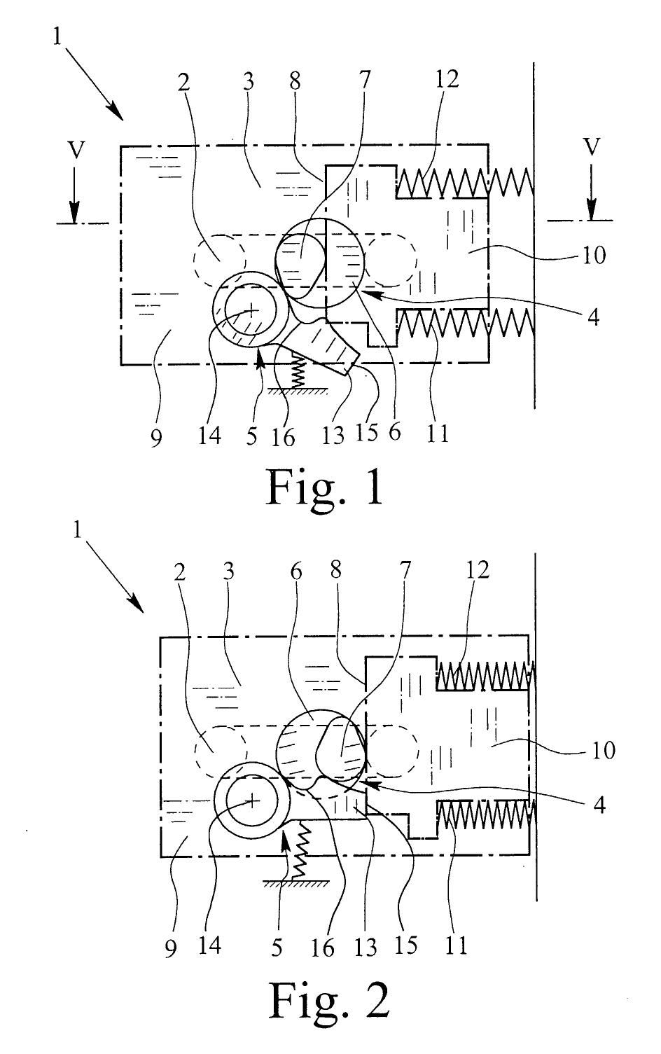

FIG. 1 shows the basic structure of the latch drive assembly 1 of the invention. The latch drive assembly 1 is composed of a lock latch 2 which is located on the latch carrier 3, of a drive 4 and a blocking arrangement 5. The latch is connected to the latch carrier 3 via a rivet, screw or weld connection.

The latch carrier 3 is guided such that it can be moved between two positions, the pre-closed position and the main closed position. Displacement from the pre-closed position into the main closed position is hereinafter called locking. The pre-closed position in normal operation is the position which the latch carrier 3 assumes when the vehicle door is opened and can be slammed by the user. The main closed position is accordingly assumed to be when the vehicle door is closed. Unlocking here means the displacement of the latch carrier 3 from the main closed position into the pre-closed position.

The blocking arrangement 5 has the function of keeping the latch carrier 3 in the main closed position. For this reason the blocking arrangement 5 can be moved into the blocking position when the latch carrier 3 is located essentially in the main closed position. “Essentially” here means that the latch carrier 3 has not yet arrived in the main closed position, or that it has been displaced beyond the main closed position.

The displacement movements of the latch carrier 3 both for locking and unlocking can be controlled by means of the drive 4. In doing so, the drive 4 performs the corresponding locking sequence for locking and the corresponding unlocking sequence for unlocking, and these sequences to be executed by the drive 4 by an individual movement, and also by complex movements. Additionally, it is within the scope of the present invention for the sequences to contain several movements which are independent of one another.

Initially, it must be noted that the latch carrier 3 can be moved at any time, without mechanical interaction with the drive 4, from the pre-closed position into the main closed position. This is of special significance in the situation of a fault, particularly, when the drive 4 fails due to lack of power.

According to the preferred embodiment of the invention, the blocking arrangement 5 is mechanically pre-tensioned, such as by a spring, such that it automatically assumes its blocking position when the latch carrier 3 is moved into the main closed position. This means that regardless of how the latch carrier 3 travels into the main closed position, it is held by the blocking arrangement in the main closed position.

This function is particularly advantageous in the situation when the drive 4 fails, since then the latch carrier 3 must be moved manually into the main closed position and the latch carrier 3 will remain there due to the blocking action of the blocking arrangement 5.

In order to achieve a closed unlocking and locking cycle controlled by the drive 4, it is desirable that the blocking arrangement 5 be moved out of the blocking position again back into a non-blocking position by means of the drive 4. In one advantageous embodiment, there is a mechanical coupling between the drive 4 and the blocking arrangement 5 such that the blocking arrangement 5, during the unlocking sequence of the drive 4, is first moved into a non-blocking position so that then unlocking is carried out in a controlled manner by the drive 4.

Thus, the blocking arrangement 5 is therefore automatically moved by the drive 4 into the non-blocking position so that the main closed position and the pre-closed position can be cyclically assumed by means of the drive 4.

One particular advantage, especially with respect to noise development during unlocking, is achieved by the drive 4 and the latch carrier 3 being coupled such that, during the unlocking sequence, displacement of the latch carrier 3 does not occur until the blocking arrangement 5 has been transferred into the non-blocking position. If, at this point, the mechanical coupling between the drive 4 and the latch carrier 3 is made such that the displacement of the latch carrier 3 during the unlocking sequence takes place exclusively in a continuous movement, then discontinuous, sudden movements of the latch carrier 3 do not occur. This means in turn that the noise development, which might be expected during unlocking, is minimized.

When the latch carrier 3, in an emergency, has been moved into the main closed position and the blocking arrangement 5 has dropped into the blocking position, the latch carrier 3 is prevented from falling back uncontrollably into the pre-closed position in the course of a locking cycle by the special configuration of the mechanical coupling between the drive 4 and the blocking arrangement 5.

The prior art offers numerous possibilities for embodying the drive 4. One possibility is providing a drive 4 comprises an electric motor, gearing and a cam 6 with an eccentric bolt. For the electric motor all conceivable motor types can be used. When the drive 4, as shown in FIG. 1, is provided with a cam 6 with an eccentric bolt 7, the latch carrier 3 has a contact surface 8, preferably in the form of a crank. The eccentric bolt 7 then mechanically interacts with the contact surface 8 or the crank. Then, displacement of the eccentric bolt 7 causes a corresponding displacement of the latch carrier 3.

The latch drive assembly is made particularly compact when the latch carrier 3 is composed of a clip plate 9 and an auxiliary plate 10. The auxiliary plate 10 is rigidly connected to the clip plate 9 and is preferably located parallel thereto. The lock latch 2 is in turn located on the clip plate 9. The auxiliary plate 10 is used essentially to hold the contact surface 8 or the crank.

The latch drive assembly 1 of the invention can be efficiently implemented when the latch carrier 3 is mechanically pre-tensioned, without mechanical action, in the pre-closed position. One simple implementation of this pre-tensioning includes providing compression springs 11, 12 which act on the latch carrier 3, either on the clip plate 9 or on the auxiliary plate 10 or both. In this case, control of the locking and unlocking by the drive 4 is reduced to acting against the force of this pre-tensioning of the latch carrier 3.

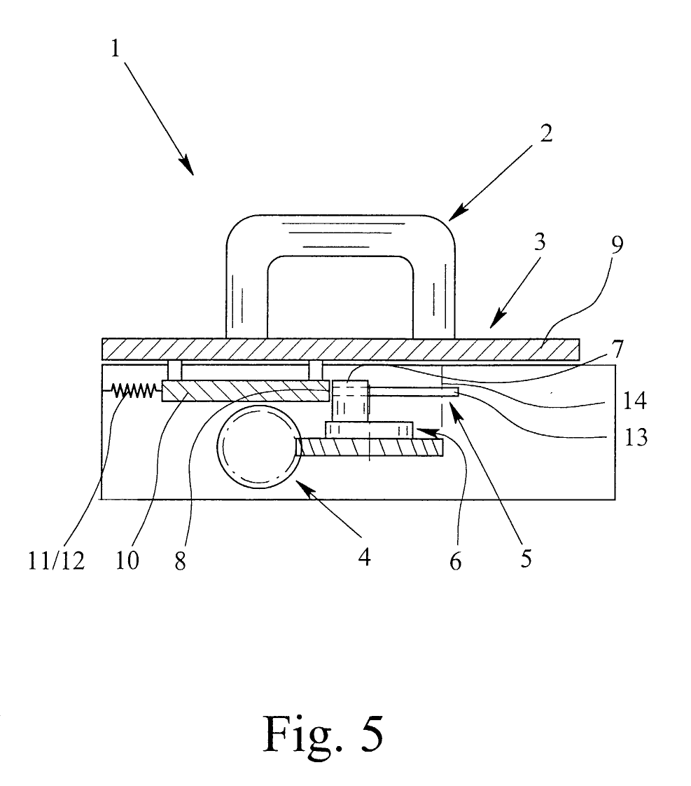

In one particularly preferred embodiment, the blocking arrangement 5 is constructed with a catch 13 which can be swiveled around a pivot 14. In the blocking position, the catch 13 makes contact with the latch carrier 3, via contact surface 8, such that it is held in its main closed position. Preferably, the catch 13 has a surface which is located tangentially to the swiveling motion, i.e., the blocking surface 15, which accordingly comes into contact with the latch carrier 3 at contact surface 8. The catch 13 is then arranged such that the holding force which is required for holding the latch carrier 3 is accommodated by the blocking surface 15. As a result, the catch 13 is only compressively loaded. FIGS. 2 and 5 illustrate this arrangement. Here, the holding force is diverted directly from the contact surface 8 and the auxiliary plate 10 onto the blocking surface 15 of the catch 13 and thus into the pivot 14. In the embodiment shown in FIG. 2, the holding force is determined by the two compression springs 11, 12.

As described above, since there is mechanical coupling between the drive 4 and the latch carrier 3 as well as between the eccentric bolt 7 and the contact surface 8, displacement of the latch carrier 3 essentially does not occur during the unlocking cycle until moving of the catch 13. In order to ensure these mechanical couplings, which include positive and non-positive interactions, a special configuration of the catch 13, of the eccentric bolt 7 and of the latch carrier 3 is necessary.

The mechanical interaction with the latch carrier 3 takes place via the auxiliary plate 10 which makes available a straight contact surface 8. According to one especially preferred embodiment the contact surface 8 can be curved.

The eccentric bolt 7, according to the preferred embodiment, is essentially cam-shaped in cross section. With a cam-shaped eccentric bolt 7, it is thus possible to move the catch 13 during the unlocking cycle of the drive 4, which results in a corresponding displacement of the eccentric bolt 7; while at the same time leaving the latch carrier 3, whose position is controlled essentially by the eccentric bolt 7, in the main closed position, as was described above.

The catch 13 on the side facing the eccentric bolt 7 has a type of hook which is pressed to the outside when the catch 13 is moved by the eccentric bolt 7. Furthermore, the catch 13 has a shaped area 16 which corresponds to the eccentric bolt 7 and into which the eccentric bolt 7 fits when the latch carrier 3 is moved manually into the main closed position.

For guidance of the latch carrier 3, linear guidance is preferred, as shown in FIG. 1. This linear guidance of the latch carrier 3 leads to an especially simple and durable implementation. However, there are a host of other possible embodiments of the guidance of the latch carrier 3, such as for example a swiveling guide. Reference is made to the previously discussed prior art in this respect.

The guidance of the latch carrier 3 as a linear slideway 17 requires relatively little complexity. In particular, it can be advantageous to enclose the latch carrier 3, at least partially, with a slippery plastic. In a corresponding configuration, the plastic jacketing can be used as part of the linear slideway. If, for example, the plastic jacketing is made such that it is formed over the length of the latch carrier 3 in a T-shaped cross section or the like, it would then be possible to have the T-shaped, jacketed latch carrier 3 interact with a corresponding counterguide in the manner of a slideway. Optionally, there can be somewhat raised slide surfaces on the latch carrier 3 which run on corresponding guide surfaces. When the latch carrier 3 is provided with plastic jacketing, this jacketing can be used for various other purposes as well, e.g., cams for triggering microswitches or supports of springs.

Since the latch drive assembly 1 of the invention is often not simply a mechanical device, but rather a mechanical-electronic device, it should be pointed out that the control of the drive 4 with the corresponding sensors must be considered in the design. In another preferred embodiment of the invention, all control components, especially circuit boards, sensors and interfaces should be located as near as possible to the drive, preferably in a housing (not shown) which may be present.

In summary, the manner of operation of the latch drive assembly of the invention is as follows. In FIG. 2 the latch carrier is in the main closed position. The catch 13 is in its blocked position. The eccentric bolt 7, after the completed locking cycle, adjoins the contact surface 8 of the auxiliary plate 10.

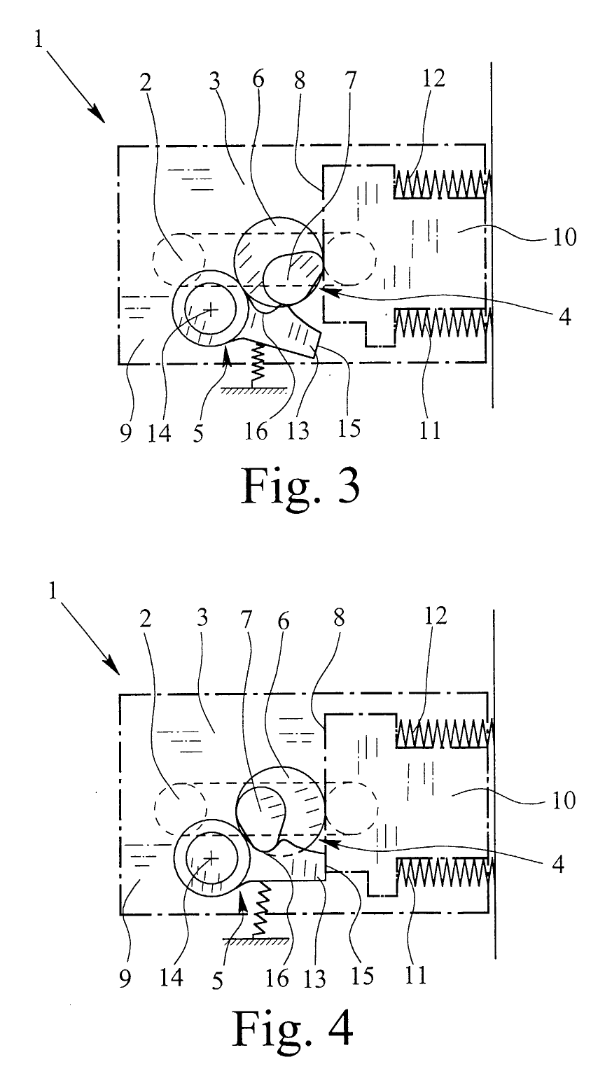

FIG. 3 shows the transition from the main closed position in FIG. 2 into the pre-closed position in FIG. 1. The eccentric bolt 7 moves in the unlocking, clockwise, cycle along the contact surface 8 without moving the latch carrier 3. At the same time, the eccentric bolt 7 moves the catch 13 so that the blocking surface 15 can no longer interact with the contact surface 8 of the auxiliary plate 10. Then, the eccentric bolt 7 continues to move so that the latch carrier 3 is moved under the force of springs 11, 12 in the direction of the pre-closed position. The catch 13 is also moved further into the un-blocked position by the pressing of the contact surface 8 of the auxiliary plate 10, until finally the latch carrier is in the pre-closed position as illustrated in FIG. 1.

In contrast to the above described actuation by the drive 4, FIG. 4 shows the condition of the latch drive assembly when the latch carrier 3 has been manually transferred into the main closed position. In this condition, the blocking arrangement 15 is in its blocking position and the eccentric bolt 7 is in the position after the completed blocking cycle. This condition occurs when, for example, the drive 4 is not serviceable due to a power failure. When the drive 4 can assume its function again, the drive 4 first executes a locking cycle without moving the catch 13, i.e., by clockwise rotation of the cam 6. Then the drive executes an unlocking cycle which in turn lifts the catch 13, as already described, and causes unlocking.

What is claimed is:

1. Latch drive assembly for a motor vehicle door lock comprising
a lock latch,
a latch carrier rigidly connected to the lock latch and adapted for alternating displacement movement between a pre-closed, unlocked position and a main closed, locked position,
a drive mechanically coupled to the latch carrier and adapted to execute a locking sequence and an unlocking sequence for the lock latch, and
a blocking arrangement which when the latch carrier is in the main closed position, is adapted to be moved into a blocking position for holding the latch carrier in the main closed position,
wherein the drive, when the blocking arrangement is not in the blocking position, enables controlled displacement movements of the latch carrier during both the locking and unlocking sequence and the latch carrier is capable of movement from the pre-closed position into the main closed position without action of the drive, and
wherein the blocking arrangement is mechanically pre-tensioned such that the blocking arrangement moves into the blocking position when the latch carrier is moved into the main closed position.

2. Latch drive assembly as claimed in claim 1, wherein the drive is mechanically coupled to the blocking arrangement to enable the blocking arrangement to be moved by the drive into a non-blocking position.

3. Latch drive assembly as claimed in claim 2, wherein the mechanical coupling between the drive and the blocking arrangement enables the blocking arrangement, during the unlocking sequence of the drive, to be first moved into the non-blocking position and thereafter the controlled displacement movement of the unlocking sequence is carried out by the drive.

4. Latch drive assembly as claimed in claim 3, wherein the mechanical coupling between the drive and the latch carrier does not enable displacement movement of the latch carrier during the unlocking sequence until after the blocking arrangement is moved into the non-blocking position.

5. Latch drive assembly as claimed in claim 1, wherein the mechanical coupling between the drive and the latch carrier enables a continuous displacement movement of the latch carrier during the unlocking sequence.

6. Latch drive assembly as claimed in claim 2, wherein, during movement of the latch carrier from the pre-closed position into the main closed position without action of the drive, the mechanical coupling of the drive to the blocking arrangement enables the blocking arrangement to remain in the blocking position.

7. Latch drive assembly as claimed in claim 1, wherein the drive comprises a cam with an eccentric bolt and the latch carrier comprises a contact surface which is adapted to interact with the eccentric bolt such that the latch carrier can be moved upon displacement of the cam and eccentric bolt.

8. Latch drive assembly as claimed in claim 7, wherein the latch carrier further comprises a clip plate and an auxiliary plate, wherein the clip plate is rigidly connected to and parallel with the auxiliary plate and further wherein the lock latch is located on the clip plate and the auxiliary plate includes the contact surface.

9. Latch drive assembly as claimed in claim 1, wherein the latch carrier includes a means to mechanically pre-tension the latch carrier toward the pre-closed, unlocked position.

10. Latch drive assembly as claimed in claim 9, wherein the means to mechanically pre-tension the latch carrier includes at least one compression spring.

11. Latch drive assembly as claimed in claim 7, wherein the blocking arrangement comprises a catch adapted to be swiveled around a pivot, wherein the catch includes a tangentially located blocking surface adapted to come into contact with the contact surface of the latch carrier so that a holding force for holding the latch carrier in the main closed position is accommodated by the blocking surface.

12. Latch drive assembly as claimed in claim 11, wherein the catch has shaped area adapted to interact with the eccentric bolt depending on the position of the eccentric bolt.

13. Latch drive assembly as claimed in claim 7, wherein the eccentric bolt has a non-circular cross section providing a cam surface which interacts with the contact surface.

14. Latch drive assembly as claimed in claim 1, wherein the latch carrier is adapted for linearly guided, alternating displacement movement between a pre-closed, unlocked position and a main closed, locked position.

15. Latch drive assembly as claimed in claim 14, wherein the linearly guided, alternating displacement movement is via a slideway.

16. Latch drive assembly as claimed in claim 15, wherein the latch carrier is at least partially enclosed by a slippery plastic to facilitate movement of the latch carrier on the slideway.

17. Latch drive assembly as claimed in claim 1, further including a means for controlling the drive wherein the means of controlling the drive is located within a housing in the vicinity of the drive.
